(19) United States
(12) Patent Application Publication
(10) Pub. No.: US 2008/0065904 A1
(43) Pub. Date: Mar. 13, 2008

(54) Reproduction of compact discs and DVDs

(75) Inventor: Melvin Clark, Minneapolis, MN (US)

Correspondence Address: Mark A. Litman & Associates, P.A.;York Business Center, Suite 205, 3209 West 76th St., Edina, MN, 55435, US

(73) Assignee: Global Discware

(21) Appl. No.: 11/519,639

(22) Filed: Sep. 12, 2006

(51) Int. Cl. G06F 12/14

(52) U.S. Cl. 713/193; 710/1; 711/162

(57) ABSTRACT

A system and method for controlling duplication of data on discs on-line. There is a disc duplication device having software embedded therein for directing the transfer of information from an information source to multiple discs. There is also an I/O port for connecting a processor in the disc duplicating device to a main processor. The processor for the duplicating device is directed by memory stored in the disc duplicating device to move discs and to transfer information from a disc in the disc duplicating device to multiple discs in the disc duplicating device. The main processor provides direction on the number of duplicate discs to be duplicated and authorizes or denies authorization to specific disc duplicators in communication with the main processor.

### BACKGROUND OF THE INVENTION

1. Field of the Invention

The present technology relates to the reproduction of information recorded on CDs and/or DVDs, and the reproduction of such information in a mass production format as opposed to single CD or single DVD reproduction.

2. Background of the Art

The production and reproduction of disc-based information media such as CDs and DVDs is usually accomplished by providing a blank, writeable information-receptive element (CD or DVD disc) on a spindle, rotating the disc, and performing a writing function onto the writeable layer(s) of the disc, usually while the disc is being rotated. Writing is typically accomplished by optical or thermo-optical writing steps with focused or coherent electromagnetic radiation (e.g., light-emitting diodes, lasers, imaging through masks). The writing on the disc is either permanent when written or is made permanent after initially written on the disc. It is relatively simple to write onto a single disc, but the manufacture of larger volumes of discs is not economically accomplished by writing single discs, one-at-a-time at play speeds (i.e., 1× play speeds). It is therefore necessary to at least write discs at multiple play speeds (e.g., 2×, 4×, 5×, 8×, 10×, 12×, 16× and more) to mass produce the CDs or DVDs. This mass production is now often performed on towers in which stacks of discs with multiple writing heads (LEDs or lasers) that can provide the same imaging optical/electromagnetic pattern onto multiple discs on multiple spindles. Such systems are referred to as towers and are accompanied by software suites that enable the operator to select and control certain parameters in the manufacture of the disc-based data carrying medium production. These might include, by way of non-limiting examples,

DVD Burning Media Suites: usually include DVD burning, DVD Authoring, DVD Editing, and DVD Copy applications in one bundle. Commercially available system include, again by way of non-limiting examples, Roxio Easy Media Creator 8; Pinnacle Studio MediaSuite; CopyToDVD 3.0; Cheetah DVD Burner; Gear DVD 7; Gear Pro “Professional Edition” DVD 7; and Gear Pro “Mastering Edition” 7.

The DVD Tracer Pro DVD Copier Series is a combination DVD/CD Recordable Tower Duplication System featuring high performance General Purpose DVD±R recorders, which may be used for applications requiring the large capacity of DVD media, including video, medical imaging, long term data storage, data interchange, and many others. These units also support CD-R, providing users with dual functionality and versatility. Their user interface, combined with one button operation, allows any novice user to duplicate multiple general purpose and non-secured video DVD's, and CD's as well. Since the DVD Tracer Pro Series is completely standalone with an internal hard drive, no PC is required for operation. 80 GB Hard Drives are now standard in all DVD Tracer Pro Towers. Multiple cooling fans and a rugged enclosure are provided with the DVD Tracer Pro Series, which also includes USB 2.0 port to connect the Tracer Tower to a PC or MAC host. It is available with Dual Format Dual Layer (DFDL) Drives: 16× DVD±R and 48×CD-R format, with Dual Layer Technology, capable of recording up to 8.5 Gigabytes. The CD Tracer Pro Data sheet includes the following features:

Standalone CD/DVD recordable duplication system

One button operation

Internal hard drive for multiple image storage

Available in 2 to 9 drive configurations

Compatible with any general purpose DVD media

Menu commands include: load to hard drive, copy (disc-to-disc), copy and compare, verify, emulate, compare.

Optical disks of a music CD standard, and optical disks of a DVD (digital versatile disk) standard capable of recording images have become widespread as information recording media, that is, as optical disks that can record information using light beams.

As current DVD standards, there are a read-only DVD-ROM standard, write-once type DVD-R standard, rewritable type (about 1000 times) DVD-RW standard, and rewritable type (more than 10000 times) DVD-RAM standard.

Note that in the optical disks of the rewritable type DVD-RW standard and the DVD-RAM standard, it is required to initialize a recording layer (recording film), that is, a phase change layer.

To initialize the recording film, a method of using, for example, radiant heat from a lamp has been proposed. Further, to initialize the recording layer, a method of irradiating an elliptic beam onto the entire surface of an optical disk has also been proposed. The recording film is continuously exposed with the elliptic beam. However, the known technology only describes a method of applying radiant heat onto the entire surface of the disk and describes nothing as to a case where two or more recording layers (recording films) are employed. Published US Patent Application 20050058034 provides an information recording medium and an information recording method that can stably record and reproduce information to or from an information recording medium capable of recording and reproducing information to and from two recording layers from one side thereof and can eliminate an effect of a crosstalk. In the invention, premarks (different from initialization) are formed to each of first and second recording layers of an information recording medium simultaneously with the initialization of the respective recording layers using an elliptical laser spot. With this operation, information can be stably reproduced from an information recording medium having at least two recording layers.

In contrast, a laser beam can be exposed in association with a time during which it passes through one point on a recording layer. However, since the laser beam is irradiated on the premise that it continuously exposes the recording layer so that the entire surface thereof is uniformly initialized, a case where two or more recording layers (recording films) are employed is not described in the publication. Incidentally, in a DVD optical disk having two or more recording layers, a system for reading information recorded on two layers from one side of a reproduction-only type optical disk has become commercially practical. However, a recordable or rewritable type information recording medium, in which information is recorded to two or more recording layers from one side thereof or information is reproduced from an arbitrary recording layer, has not almost become commercially practical.

U.S. Pat. No. 7,050,368 (Saito) describes a system for managing the number of duplicates of digital data even when a variety of recording mediums capable of repeated recording are used. The statement of the values of the number of seconds of the recording time recorded in a UTOC sector 2 of a mini-disc is differentiated between a case of recording using a conventional duplication route duplicating the audio data from a CD block (4) and a case of recording using a new duplication route of duplicating audio data from a hard disc (3) through a host controller (2). The recording time the statement of which is differentiated depending on the routes of duplication or the discrimination information of the audio data is managed by the host controller (2) to perform duplication number management.

In this duplication management system, a recording device and a duplication management device in which, even with the use of variable recording mediums, it is possible to supervise the number of duplicates of digital data. Accomplishing this is done by providing a duplication management method for duplicating the main information to a recording medium having a main information area in which the main information is recorded and a management area in which the management information for each item of the main information recorded in the main information area is recorded, wherein the main information can be duplicated to the recording medium through one of a first route for duplicating the main information without performing duplication number management and a second route for duplicating the main information with duplication number management. The statement of a portion of the management information for the main information duplicated to the recording medium through the first route is differentiated from the statement of a portion of the management information for the main information duplicated to the recording medium through the second route. The portion of the management information is stored and held as duplication hysteresis information at least in case the main information is duplicated to the recording medium through the second route. With this duplication management method, the statement of the portion of the management information recorded in the management area of the recording medium in association with the main information is differentiated between the case of recording the main information through the first route on the recording medium and the case of recording the main information through the second route on the recording medium. The portion of the management information, the statement of which is differentiated depending on the routes of duplication, is stored as the duplication hysteresis information on the part of the duplication management device (host controller) or on the part of a device outputting main data. In this manner, it can be clearly distinguished, based on the portion of the management information, the statement of which is differentiated depending on the duplication routes, whether the main information recorded on the recording medium has been recorded through the first route not performing duplication number management on the main information or through the second route performing duplication number management on the main information. If the main information has been recorded through the second route, and is deleted as it is returned to the source device, it is checked, based on the statement of the portion of the management information of the recording area different depending on the duplication route and on the duplication hysteresis information, whether or not the main information is that supplied from the source device. If it has been found that the main information deleted from the recording medium is the main information from the source device, the number of times of possible duplication of the fraction of the main information deleted from the recording medium is returned to the source device to enable further duplication of the main information from the supply device.

Watermark information, duplication limiting embedded information, single copy limiting commands and other embedded orders are disclosed in Published US Patent Application No. 20030117920 (Saito). This information may be effected through a management system for information with a portion of the management information, the statement of which is to be differentiated, may be an equipment identifier of a recording equipment used in recording the main information on the recording medium. That is, the equipment identifier of a recording equipment used in recording the main information on the recording medium is differentiated between the case of recording the main information on the recording medium through the first route and that of recording the main information on the recording medium through the second route. Thus, even if the main information has been recorded using the same recording device, it can be clearly determined whether the main information has been recorded through the first route or through the second route, with the aid of the equipment identifier recorded in the management area of the recording medium in recording the main information on the recording medium. Moreover, it can be determined, based on the description of the equipment identifier, whether or not the recording medium in question is the recording medium supplied with the main information from a preset supply source.

Numerous technologies are available for the writing of quality DVD or other optically readable rotating or circular data media, the following providing a non-limiting list of such disclosures, which are incorporated herein by reference, U.S. Pat. Nos. 6,222,813; 6,151,286; 6,128,262; 6,118,740; 6,115,339; 6,111,830; 6,108,282; 6,097,681; 6,097,677; 6,088,317; 6,088,309; 6,088,306; 6,081,487; 6,075,764; 6,049,512; and 6,031,962.

The Aleratec 1:5 DVD/CD Auto Copy Tower is a new robotic duplication system incorporating the highest disc recording speeds and robotic disc handling in a package that facilitates higher productivity and hence is more cost effective than manual duplicating products. Business, government and education offices, audio and video professionals, software and game developers, graphic artists, churches, private organizations, and individual video enthusiasts are constantly looking for more effective methods of duplicating and handling DVDs and CDs for customers, clients, employees, students, organization members, etc. The need to duplicate and publish both DVDs and CDs with total control of the schedules, quantity and content has been growing since the first Optical Technology Recorders came on the scene. Until now, the necessary equipment has been hard to understand and operate, and very expensive. The Aleratec 1:5 DVD/CD Auto Copy Tower with advanced robotic disc handling is unique in stand alone DVD duplication systems providing automated, unattended, duplication of high quality DVDs and CDs. The Aleratec 1:5 DVD/CD Auto Copy Tower automatically duplicates DVDs and CDs with no operator intervention required. Load a source disc image to the 160 GB HDD and up to 200 pieces of blank media, it can duplicate up to 200 discs per job completely unattended. The DVD/CD Auto Copy Tower incorporates the latest 16× DVD recording technology that can make 5 simultaneous copies of two hours of video in as few as 6 minutes per cycle of the 1:5 DVD/CD Auto Copy Tower. That translates to less than 1.2 minutes per DVD.

With the DVD/CD Auto Copy Tower, duplication speeds for DVDs can be done at speeds up to 16× using 16× certified media. The DVD/CD Auto Copy Tower can also copy up to 8.5 GB on Double Layer Media at up to 4× taking advantage of the latest Double Layer recording technology. The Aleratec 1:5 DVD/CD Auto Copy Towers incorporate a built in 160 GB hard disk drive to store frequently used source disc images and the hard disk maximizes copying stability especially in high speed copying operations.

The Microboards Olympus™ tower is a simple to operate, mid-level throughput duplicator that does not require a PC. Single Button operation and twin high-speed drives make the Olympus an easy way to copy quickly and painlessly. The master disc and blanks are inserted in the Olympus's 100 disc input hopper. When the start button is pressed, the master is read first by the recorders. A disc image is created on the Olympus's hard drive, and burned to the subsequent blanks in the recorder. Finished discs are dropped into the caddy below. If Olympus finds another master disc in the input, it will overwrite the hard drive image and start recording the new data to the following blank discs.

Features include:
Easy-Load System has Minimal moving parts making it safe and reliable
Completely standalone, no PC required
Can Copy Both CDs & DVDs
Based on award-winning loading & copying technology
Compact footprint

### The Microboard series includes a range of towers in their DVD Tower Duplicator Series.

The new Standard and Premium range of Microboards DVD towers are an affordable, professional—level DVD copying system that is easy to use and fully contained, operating without being connected to a computer. The standard range supports up to 8× recording as well as dual layer recording. A two line LCD display and simple two button interface make accessing those features easy for even novice users. This range comes in configurations of 3, 5, 7, 10 and 16. The premium range supports up to 16× recording as well as dual layer recording. This range comes in configurations of 3,5,7,10 and 16. Supported DVD Formats include DVD Video, DVD ROM, DVD+R, DVD-R, DVD-RW, DVD+RW, and Dual Layer DVD. DVD Duplicators do not record CD+G Format. PC Connect Option An Optional PC Connection is also available on DVD Duplicators by purchasing the FireWire (IEEE 1394) or USB 2.0 interface module for mastering.

### SUMMARY OF THE INVENTION

The present technology relates to a web-based system for operational and job control of circular data storage disc (CD and DVD) replication and the apparatus and software and processes used therewith. Communication is established between at least the local operator duplicating tower and a central Main Processor of the service provider. Calls are encrypted and take place over a secure socket or I/O port. Each duplicating apparatus (e.g., the tower) has a unique embedded identification (e.g., serial number) and each apparatus is provided with an assigned user account which is identified at both the tower site and at the Main Processor site. Specific software modules at each distinct tower or grouping of towers may have separate licenses and can have separate effective dates for the duration of the licenses. The service provider's (e.g., Global DiscWare's) main application on the Main Processor can disable any module based on activation code information (e.g., particularly detected forged, counterfeit, unauthorized, account-default, etc.). An original job connection between the Main Processor and the local tower acting in a Master-Slave capacity might well operate as follows:
1. The tower connects to the Global DiscWare's main application through the internet and submits its serial number.
2. The main application retrieves account information, including license effective status, and date range for the license. If the license is in good standing and good for the time period, the main application validates the serial number and generates a license code. This license code is added to the main application database.
3. The main application returns the activation code to the requesting tower.
4. The tower updates the activation code and effective dates, and uses this information to update the license information.
5. The tower sends confirmation to the main application through the internet.
6. The main application validates the acceptance and returns an activation key to the tower. The activation key is unique for the specific machine.

### BRIEF DESCRIPTION OF THE FIGURES

FIG. 1 shows an opening screen shot of a display of the present technology.

FIG. 2 shows a screen shot of Project details.

FIG. 3 shows a screen shot of the Project Manager Wizard.

FIG. 4 shows a screen shot of Project Details.

FIG. 5 shows a screen shot of the Job Manager.

FIG. 6 shows a screen shot of the Job Master.

FIG. 7 shows a screen shot of the Production Scheduler.

FIG. 8 shows a screen shot of the Production Scheduler—Selected Project.

FIG. 9 shows a screen shot of Schedule Job Detail.

FIG. 10 shows a screen shot of the Label Maker.

FIG. 11 shows a screen shot of a label from a template.

FIG. 12 shows a screen shot of a System Alert.

FIG. 13 shows a screen shot of the Address Book.

FIG. 14 shows a screen shot of a Systems Manager Alert.

FIG. 15 shows a screen shot of the System Manager—Tower Details.

FIG. 16 shows a screen shot of the License manager opening page.

FIG. 17 shows a screen shot of the License Manager—Offline Activation.

FIG. 18 shows a screen shot of the Global Discware shopping store.

FIG. 19 shows an Address Book with an order from the store.

FIG. 20 shows a screen shot of the New Contact page.

FIG. 21 shows a screen shot of the Change Password page.

FIG. 22 shows a screen shot of the User Manager page.

FIG. 23 shows a screen shot of the User Details page.

FIG. 24 shows a screen shot of the System Configuration.

FIG. 25 shows a screen shot of the Project Manager page opened.

FIG. 26 shows a screen shot of the Project Details with status report.

FIG. 27 shows a schematic of a system according to the present disclosure.

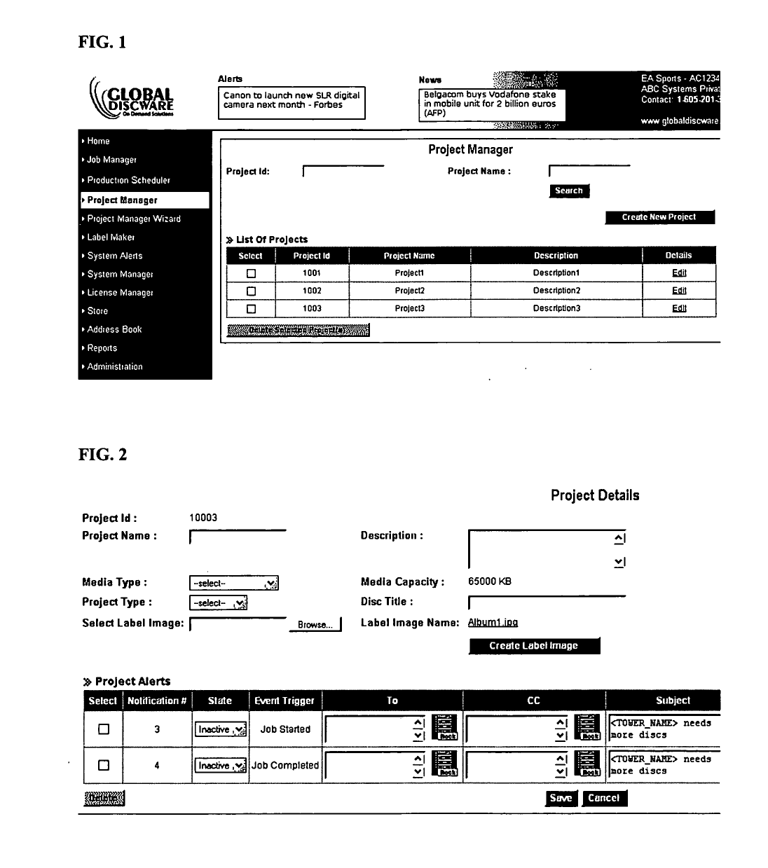

### DETAILED DESCRIPTION OF THE INVENTION

There is commercial technology available for the private or commercial reproduction of video discs known as CD duplicators, DVD duplicators, CD/DVD duplicators and the like. These systems may duplicate information onto one or more discs (CDs or DVDs) at the same time. Among the commercial systems available, in addition to those listed above in the Background of the Art are such tower systems such as the Olympus CD Duplicator, Manufactured by Microboards and sold as Part #: GM-1000-01. The Olympus system will be used as a focus on how duplicators are used, but is only a non-limiting example of a generic component (the duplicator) that may be used in the practice of the present technology. This particular duplicating tower is a simple to operate, mid-level throughput duplicator that does not require a stand-alone PC on-site. Single Button operation and twin high-speed drives make the Olympus an easy way to copy quickly and painlessly. The master disc and blanks are inserted in the Olympus's 100 disc input hopper. When the start button is pressed, the master is read first by the recorders. A disc image is created on the Olympus's hard drive, and burned to the subsequent blanks in the recorder. Finished discs are dropped into the caddy below. If the Olympus Duplicator finds another master disc in the input, it will overwrite the hard drive image and start recording the new data to the following blank discs. Whenever the system recognizes a new master, it reads it into the hard drive, ejects the master into the output bin, and starts recording the next series of blanks; until it runs out of media or recognizes a new master in the drive. The system is generally useful for at least Mid-level Duplication Quantities; Completely standalone processes, no PC required; and 100 disc input capacity.

An underlying background for the practice of some aspects of the generic technology described herein resides in the use of on-line (e.g., web-based, internet transmission) communication between each individual duplicating apparatus and a central or main processor from the service provide that operates the duplicating tower in a Master Slave or thin client relationship. The informational work for the duplication procedures is roughly (although not absolutely and completely divided) as follows. The information content that is to be downloaded or duplicated on the disc is stored or sourced from the local user, either from a disc, server, memory or separate on-line source. The operational functions for directing a project and managing a project come through or from the Main Processor at the service provider.
1. The tower connects to the Global DiscWare's main application through the internet and submits its serial number or other identification to verify identity of the reproduction unit or to establish an account, license or software download connection.
2. The main application (Main Processor) retrieves account information, including license effective status, and date range for a use license from a database established for access by the Main Processor. If the license is in good standing and good for the time period in which a project is projected for completion, the main application validates the serial number and generates a license code. This license code is added to the main application database.
3. The main application returns an activation code to the requesting tower to instruct the tower to initiate a duplication event, procedure or project, or simply power-up.
4. The tower updates the activation code and effective dates, and uses this information to update the license information.
5. The tower sends confirmation to the main application through the internet on the status and/or acceptance of the license information and the status of any proposed project.
6. The main application validates the acceptance and returns an activation key to the tower.
7. The activation key is unique for the specific machine and signals from the Main Processor to the tower containing the activation key will be accepted by the tower and the requested commanded tasks will be performed.

A function of the described Global DiscWare's Olympus Tower (this term “Olympus Tower” often will be used as a generic term for duplicating devices as opposed to this term being a reference to a specific duplicator or other CD/DVD duplicating device, unless otherwise specified as specific) and Olympus Application is to publish/duplicate CDs or DVDs in quantities from one to 10,000 discs. Users configure the system and control production remotely through the Internet or an intranet. In one embodiment, email alerts notify users when problems occur (for example, when a spindle is out of media or a ribbon breaks).

The Olympus Tower, by way of non-limiting example, contains six disc spindles, four recording drives, and an imaging system (e.g., a thermal printer). The system (e.g., when using a local source of data for duplication) designates one spindle for output. A disc transportation system (e.g., robotic arm and vacuum pickup mechanism) takes discs from the input spindle and move them to the recording drives, the printer, and the output spindle. The pickup mechanism may consist of a plurality (e.g., at least two and preferably at least three) vacuum nozzles and a guide to center the disc on the spindle. The mechanism can handle up to four discs at one time.

Users control the system through jobs and projects, for example, in the following manner.
A project is begun and the user specifies the media type (such as CD, HD-DVD, Blue Ray DVD or standard DVD), project type (such as music or video), content files, provides a label image, and designates or enters events that trigger alerts.
A selected job specifies the project, quantity requested, and preferred tower (where there are multiple towers available locally or over the internet). Users can create one-time jobs or schedule production on a daily, weekly, or other basis.
   Unique features of the Olympus Tower and Olympus Application include the following:
Scheduling
Users schedule jobs to run once or on a recurring schedule.
Remote control
All functions may be performed remotely through the internet or company intranet on any accessible tower. The user can activate or turn off towers, or specify the tower to perform a particular job.
System alerts
The system sends email notifications to alert users of problems or status changes. The user determines the events that trigger an alert and sets up an address book with addresses to receive notifications.
Operating Systems
The application runs on Linux as well as Windows and Macintosh operating systems.
Security
Security is assigned to users by role. Audit functions allow an administrator to track users' activities or terminate a specific user.
Integrated online store
Global DiscWare's online store is integrated with the user interface for enabling selection of programs and software.
RSS (Really simple systems) feeds
The user interface includes RSS feeds of news and alerts.
Remote Control Assistant
This feature allows integration through XML and FTP.
Label selection and creation
The user can select an existing graphics file for the disk label or create and edit images with a “What you see is what you get” (WYZIWYG) graphics editor.
Reseller branding
The name and contact details of the reseller/vendor are displayed in the upper-right corner of the interface.
Unicode character support
The application uses the Unicode standard to represent text characters in all languages.
J2EE compliance

The Olympus Tower (the specific device, not all duplicating devices) features that are not available on other commercial tower products. When possible, the description includes specific user processes. A J2EE- and Unicode-compliant relational database is at the core of the Olympus system. A set of database-driven modules function as separate applications (other companies do not use a database and have single applications). A software object called the Listener module detects user requests and system events, and retrieves information from the database.

### Notifications/Alerts

### Feature/Capability: The system can be set up to notify users by email or text messages when they are out of ribbon or disk, or when other status changes occur.

Background: In the user interface, the System Alerts module allows users to search, view, and edit alerts. Alerts are triggered by events and cause notifications to be sent. Every event in the replication system has a predefined alert, and users can configure additional alerts. Some events are triggered by the system and some by the user (for example, Project Started).

The system delivers notification by way of text- or HTML-based email or Small Message Service (SMS) text message.

### Process:

In the System Alerts module, the user configures an alert for a particular event trigger (for example, “Out of CDs”), selecting names and contact information for the To and CC fields and entering text for the message header and body.
A job executes and the event occurs.
The Listener module detects the event and the configured alert.
The system sends notification of the event in a text- or HTML-based email or SMS text message.

### Search

Feature/Capability: The user is able to search the database by any criteria that are entered into or generated by the system. In particular, the user can search for any CD/DVD replication job based on job name, job id, project name, project id, creation date, or status.

### Background/Process: (This description will use job creation and job search as an example.)

A user creates a job in the Job Manager module and selects a name for the project.
The system generates a Job Id and creates a database index for the job and the project name indexed according to the product name and other criteria.
At a later time, a user selects the Job Manager module and enters the job name in the search criteria's Project Name field.
The Listener module detects the search and retrieves the job.
The Job Manager module displays the job details in the user's browser.

### Activation

### Feature/Capability: Automatic online activation of the license the system makes a background call that activates the license without user intervention.

### Background/Process:

All calls should be encrypted and take place over a secure socket. Every piece of hardware has a unique embedded serial number and an assigned user account. Specific software modules have separate licenses and can have separate effective dates. Global DiscWare's main application can disable any module based on activation code.
8. The tower connects to the Global DiscWare's main application through the internet and submits its serial number or other unique identifier.
9. The main application retrieves account information, including license effective status, and date range. If the license is in good standing and good for the time period, the main application validates the serial number (unique ID) and generates a license code or unique job ID code. This license code is added to the main application database.
10. The main application returns the activation code to the requesting tower.
11. The tower updates the activation code and effective dates, and uses this information to update the license information.
12. The tower sends confirmation to the main application through the internet.
13. The main application validates the acceptance and returns an activation key to the tower. The activation key is unique for the specific machine.

### Address Book

Feature/capability: Users can set up individual addresses and groups in an address book. These addresses and groups become available for individual address books for event notifications.

### Background:

Database tables list individual contacts and groups of contacts. An individual contact includes the first name, last name, email address, and phone number of the individual. A group listing includes the same information for more than one individual. The Notification/Alerts process uses this information to set up To or CC fields for alert notifications. The user adds or removes entries through the Address Book module.

Note that when the user deletes a contact or group, that user or group does not appear to the user anymore. A deleted item may or may not be removed from the database. The corresponding information always remains in the database history.

### Processes:

To make changes to the address book, the user selects the Address Book from the left navigation bar. The Address Book screen opens.

To add a contact:
1. In the Address Book screen, the user selects the Contacts tab.
2. The user clicks the Add New Contact button. The New Contact screen opens.
3. In the New Contact screen, the user enters the First Name, Last Name, and other contact information.
4. The user clicks Save or Save & Add New.
   To edit information for an existing contact:
1. In the Address Book screen, the user selects the Contacts tab.
2. The user checks the Select box corresponding to the contact to be edited.
3. The user clicks the Edit button.
4. In the edit screen, the user types changes to the contact.
5. The user clicks the Save button.
   To delete a contact:
1. In the Address Book screen, the user selects the Contacts tab.
2. The user checks the Select box corresponding to the contact to be edited.
3. The user clicks the Save button.
   To add a group:
1. In the Address Book screen, the user selects the Groups tab.
2. The user clicks the Add New Group button. The New Group screen opens.
3. In the New Group screen, the user types a name in the Enter Group Name field.
4. To add addresses to the group, the user highlights them in the Available Email Addresses field and clicks the right arrow.
5. The user clicks the Save button.
   To add or remove addresses from a group:
1. In the Address Book screen, the user selects the Groups tab.
2. The user checks the Select box corresponding to the group to be edited.
3. The user clicks the Edit button.
4. In the edit screen, the user adds and removes addresses:
   To add an address to the group, the user highlights it in the Available Email Addresses field and clicks the right arrow.
   To remove an address, the user highlights it in the Email Addresses added to Group field and clicks the left arrow.
5. The user clicks the Save button.
   To delete a group:
1. In the Address Book screen, the user selects the Groups tab.
2. The user checks the Select box corresponding to group to be deleted.
3. The user clicks the Delete button.

### Scheduler

### Feature/Capability: The user is able schedule a CD or DVD replication job at any time, once or on a recurring basis.

### Background: The user submits dates and times through a web-enabled browser and receives notification through text- or HTML-based email or SMS text message.

Scheduled replication jobs are stored in the database. Database entries include user name, creation date, and historical information such as last execution date and next scheduled date.

At least one project (consisting of a name, a description, a set of files to burn onto the disc, and a label to print on the disk) must be defined before a job can be scheduled. See section “Create and Manage Projects” in Purpose and Processes.

Process: To schedule a CD or DVD replication job:
1. The user selects Production Scheduler from the navigation pane.
2. From the Production Scheduler screen, the user clicks Create Scheduled Jobs. The Production Manager screen opens. The Production Manager screen contains a list of available projects with a Schedule job link corresponding to each project.
3. From the Production Manager screen, the user selects a project and clicks the corresponding Schedule Job link. The Schedule Job Details screen opens.
4. From the Schedule Job Details screen, the user enters the quantity, dates, times and number of recurrences for the job.
5. The user clicks Save.
6. The database creates an algorithm that calculates occurrences of new production requests that corresponds to those dates and times.

### Thresholds

Feature/Capability: The user can set up either a re-supply limit or a percent complete limit for the THRESHOLD_REACHED alert. The system notifies the user through the alert/notification system when the limit is reached. Threshold limits can be set for each type of media: CD, single-layer DVD, and double-layer DVD.
Background/Process: When the mechanism picks a disc from a spindle, sensors detect the stack height, and the system calculates how many disks are in the spindle based on height. The system keeps track of the number of discs for each spindle and of the number for each media type. When a total for the type of media reaches the threshold set by the user, an event is triggered and an HTML or text based email, or an SMS text message, is sent to notify the user.

To set limits for the THRESHOLD_REACHED alert:
1. From the browser interface, the user selects the System Manager module.
2. From the System Manager screen, the user clicks the link for the tower.
3. In the System Manager—Tower Details screen, the Threshold Limits section, the user enters a value for the desired threshold. For example, to set a limit of 10 CDs, enter 10 in the CD text box.

### Store

Capability/Feature: An integrated commerce solution, or online store, is included as a module in the user interface. The online store redirects the customer to a reseller or Global DiscWare's store.
Background/Process: Every account, reseller or consumer, has an integrated virtual store. The virtual store is a clone of Global DiscWare's store. Every user has an ecommerce account that allows them to store address book information, payment types, and order history. The store allows customer to purchase items, services, and consumables. Services include service contracts, digital content, and CD, HD-DVD or Blue Ray DVD and DVD manufacturing or replication.

The store is integrated into the browser interface that allows users to remotely control the Olympus Tower Application. To access the store, a user selects Store from the navigation pane.

Customers make purchases by adding items or services to a shopping cart. Payment is by usual Ecommerce payment methods. An order generates an extract file with a detailed listing of all SKUs (part numbers). Quantity, shipping method, billing information, and shipping information are submitted to the Global DiscWare virtual warehouse. The virtual warehouse directs orders for items a physical warehouse. Orders for services and replication go to a fulfillment location for digital fulfillment or replication.

### Remote Control and Remote Replication

Feature/Capability: The user is able to perform all Olympus Tower control and replication functions remotely through any web-enabled device. Remote control functions include turning a tower or cluster of towers off or on, and configuring individual spindles. Remote replication functions allow the Olympus Tower to act as a remote, on-demand kiosk for CD and DVD replication.

### Background:

The user interface is available in any browser. The web browser captures information entered by the user and reposts it to the Tower's database. The database responds with content which is displayed on the browser.

The user selects modules by clicking on their names in a navigation pane. These modules are available:

### Job Manager: Create and modify jobs

### Production Scheduler: Create and modify scheduled jobs

### Project Manager: Create and modify projects

### Project Manager Wizard: Create projects through a step-by-step, easy-to-follow process.

### Label Maker: Create images or edit existing ones to be used as disc labels

### System Alerts: Set up email notifications for event triggers

### System Manager: Activate towers, configure towers, and configure spindles

### License Manager: View license information and activate towers offline

### Store: Purchase items, services, and consumables

### Address Book: Set up contact information for individuals or groups

### Reports: Access reports of job status

### Administration: Set or change an individual password (end user). Manage users or system configuration (system administrators).

### Remote Control Assistant: Allow the system to integrate with XML.

### Help: Provide step-by-step instructions for doing end user and system administrator tasks from the browser.

### Tower Names

### Feature/Capability: The system administrator is able to give logical names and logical descriptions to towers.

Process: To add or change a tower name or description:
1. The administrator selects System Manager from the left navigation pane. The System Manager screen opens.
2. The administrator selects the tower name link. The System Manager—Tower Details screen opens.
3. The administrator types a name and description in the Tower Name and Tower description fields.

### Reseller

Feature/Capability: Reseller information is displayed in the browser as part of the user interface. Reseller information is dynamic, that is, if the customer changes resellers, the information can be changed.
Process: To change the reseller information:
1. The system administrator selects Administration from the left navigation pane. The Administration pane opens.
2. The administrator selects the System Configuration link. The System Configuration screen opens.
3. In the System Configuration screen, the administrator types the Reseller name, firm name, contact information, and store URL.

### Web-Based Help Files

### Feature/Capability: The user has access to step-by-step instructions for all end user and system administrator tasks from the browser.

Process: To access the Help system, the user selects Help from the left navigation pane. The help system opens in a separate browser.

### Track Location of Discs

Feature/Capability: Olympus Tower Application tracks the location of all discs during processing. The user can search for a particular disc and find out details of its location, including the tower name, spindle number, and location on the spindle.
Process: To track the location of a disc:
1. The user selects Job Manager from the navigation pane. The Job Manager screen opens.
2. In the Job Manager screen's list of jobs, the user clicks the Job Id link corresponding to the job using the specific disc. The Job Details screen opens.
3. The Job Details screen provides tower, spindle, and the spindle depth (for example, 10 of 500) of the specific disk. (Note that the current user interface implementation does not show specific disc information.)
4. The user may need to click a further link to get specific details for the disc.

### Unicode and System Architecture

The Olympus Tower system uses a web-based, database-driven architecture, specifically designed for remote CD and DVD replication. The system incorporates a Unicode database that supports any language and can display and capture information in any database.

### Security

### Feature/Capability: The system administrator is able to set security by user role, activate or inactivate particular users, and reassign the projects owned by an inactivated user.

Background: Users are organized according to roles and groups. A role defines the user's job position; a group represents a division of the company. All features are allocated to a user group. Members of the group may have view, edit, or create privileges in a given module/feature. Data is segregated according to company and group.

### Processes:

To set up roles and groups:
1. The system administrator selects Administration in the navigation panel in the Administration screen, the administrator selects the User Manager link. The User Manager screen opens.
2. The administrator sets up roles and groups in the User Manager screen. Specific steps are to be determined.
   To reassign a user's projects to a second user:
1. The system administrator selects Administration from the navigation pane. The Administration screen opens.
2. In the Administration screen, the administrator selects the Security link. A security screen opens.
3. In the security screen, the administrator selects the Reassign link. A reassignment screen opens.
4. The reassignment screen has two regions for selecting users and their projects. The administrator selects the first user from the first user list. The corresponding project list shows the first user's projects.
5. The administrator selects the first user's projects one of these ways:
   To select all the user's projects for reassignment, click Select All.
   To select individual projects for reassignment, highlight one or more projects from the user's project list.
6. The administrator selects the second user from the second list.
7. The administrator clicks an arrow to move selected projects from the first user's project list to the second user's project list.
   To activate, deactivate, or delete users:
1. The system administrator selects Administration from the navigation pane.
2. The administrator selects the User Manager link. The User Manager screen opens.
3. The administrator clicks the Select boxes corresponding to the users to be modified.
4. The administrator modifies the selected users:
   To delete users, click Delete Selected User(s)
   To deactivate users, click Deactivate Selected User(s)
   To activate users, click Activate Selected User(s)

### RSS Feeds

### Feature/Capability: The user interface includes RSS feeds that provide news, marketing information, and system patch alerts.

Background: The RSS feeds are located in two text fields at the top of the Global DiscWare screen. Headlines rotate through the text fields. The left RSS field, labeled Alerts, provides links to system patch notifications. The right RSS field, labeled News, provides links to news and marketing articles. Users click on headlines as they appear in the text box.

RSS configuration is controlled centrally by Global DiscWare. The content is determined by demographics. Users and companies can subscribe to specific news feeds (a feed for their business segment, for example).

Global DiscWare publishes software patches to users based on demographics, business segment, and existing versions of their software.

### Process:

To read a news or marketing item:
From any user interface screen, the user clicks the News headline. The article opens in a new browser window.
   To download a system software patch:
1. The user clicks the Alerts headline. A Download Detail screen opens in a new browser window. The Download Detail screen provides a description of the problem, a description of the fix, and the download link.
2. The user clicks the download link to download the patch.

### Web-Based Reports

### Feature/Capability: The user has access to reports containing complete job status from any web-enabled device.

Process: To generate and view a report:
1. The user selects Reports from the navigation pane. The Reports screen opens. The Reports screen has a dashboard format that allows the user to pick a time interval and select filters.
2. The user specifies the time interval, either by selecting a predefined interval (such as one day, one month, three months, or one year) or by specifying a date range (for example, June 1 to August 15)
3. Optionally, the user selects a filter. These filters will be available:
   Top 10 users based on jobs created by the users
   Top 10 project users by media type in a given period
   Top 10 project users by project type in a given period
   Top 25 largest job reports for users in a given period
   List of all jobs by users
   Total quantity burned with summary

### System Overview

### Create and Manage Projects

The user creates and manages projects through the Project Manager and Project Manager Wizard modules. Each project has a unique Project Id. Projects must be defined before the user can create jobs.

### Project Manager

### The Project Manager opening screen provides a list of existing projects and fields for entering search criteria.

### Project Manager Wizard

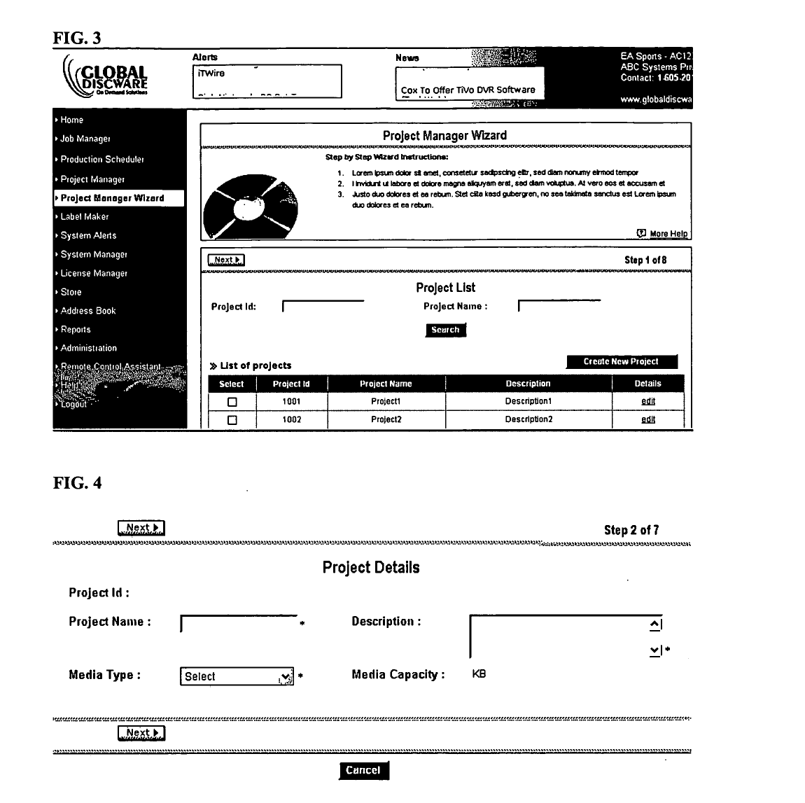

Project Manager Wizard includes the same search fields and project list as Project Manager. The wizard provides a series of steps for creating or editing a project as shown in FIG. 3. The user clicks Next to advance through the steps as shown in FIG. 4.

### Create, Schedule, and Manage Jobs

All jobs consist of one or more projects, quantity, and optionally, a tower selection. Scheduled jobs also specify a processing time or recurring schedule. Each scheduled job has both a job ID and a scheduled job ID.

### Job Manager

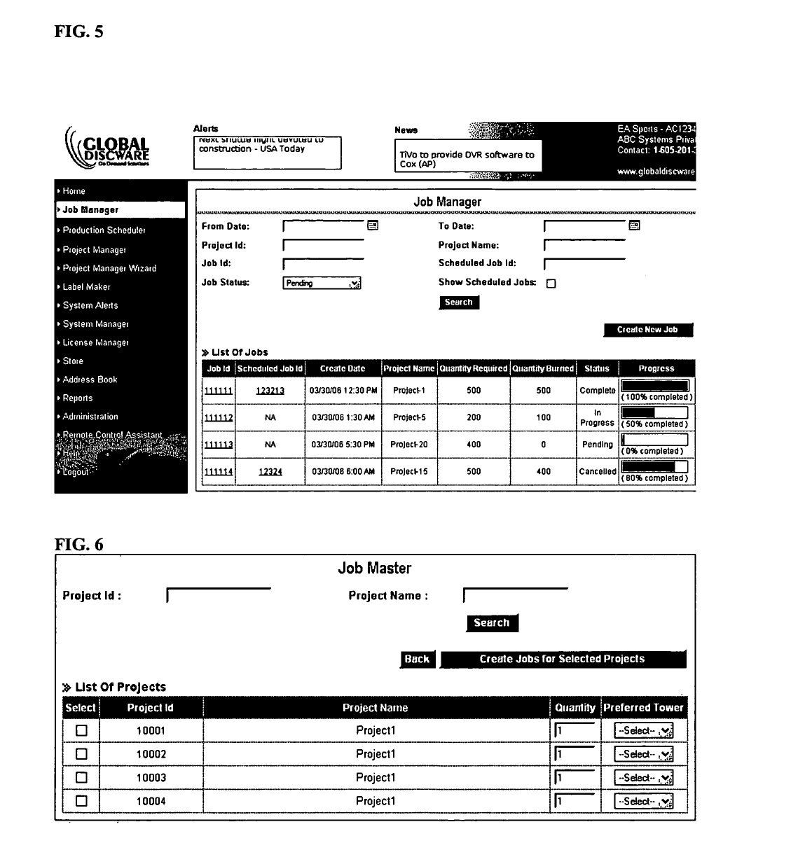

The Job Manager module allows the user to create jobs, search scheduled and unscheduled jobs, and change job details. Jobs created in the Job Manager module are put on a queue and are processed in the order that they were created, as shown in FIG. 5.

The user can create a new job by clicking Create New Job or view the status of an existing job by clicking the corresponding Job Id link.

Creating a new job, as shown in FIG. 6:

Viewing an existing job, is shown in FIG. 7.

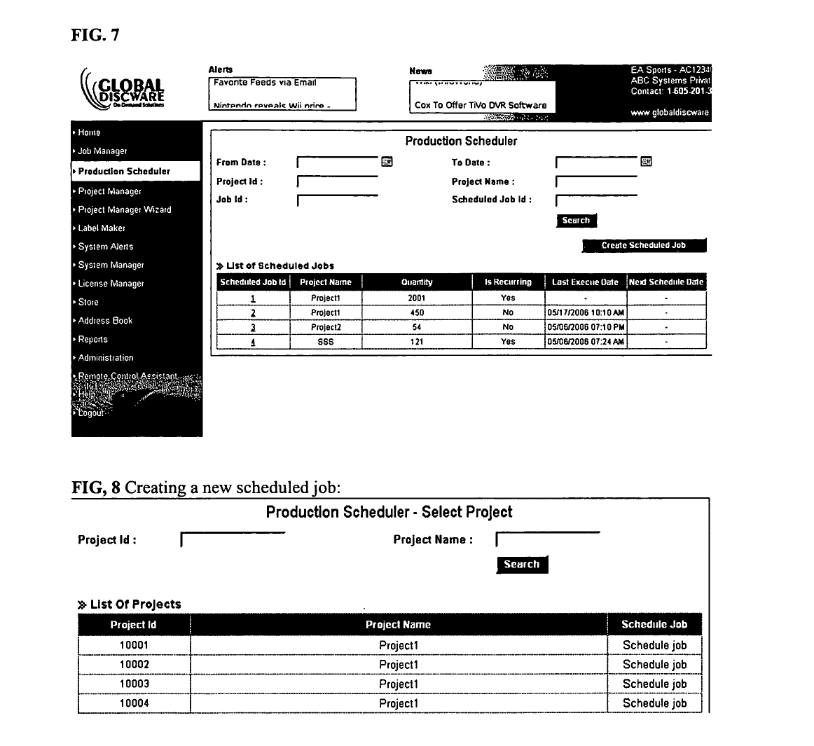

Production Scheduler The Production Scheduler module allows the user to create a scheduled job, view and search existing scheduled jobs, and change scheduled job details. A scheduled job is processed at a selected time, either once or on a recurring schedule. It has both a job ID and a scheduled job ID as shown in FIG. 8.

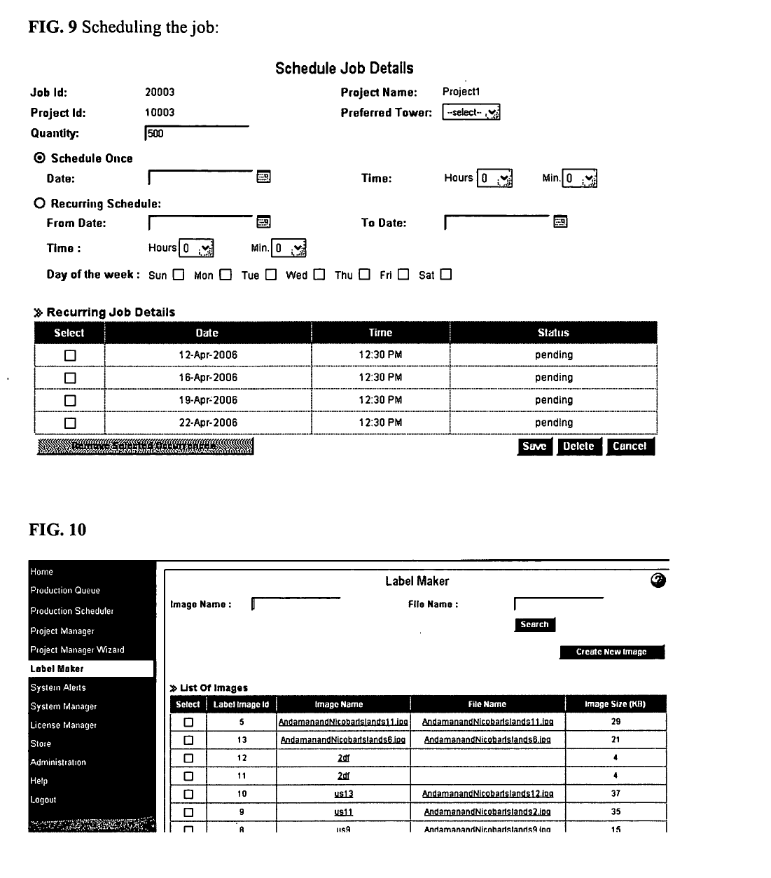

The user can create a new scheduled job by clicking Create Scheduled Job or view an existing scheduled job by clicking the corresponding Scheduled Job ID link. The series of steps involved in creating a new scheduled job and then scheduling the job are shown in FIGS. 9 and 10.

### Create or Edit Disc Labels

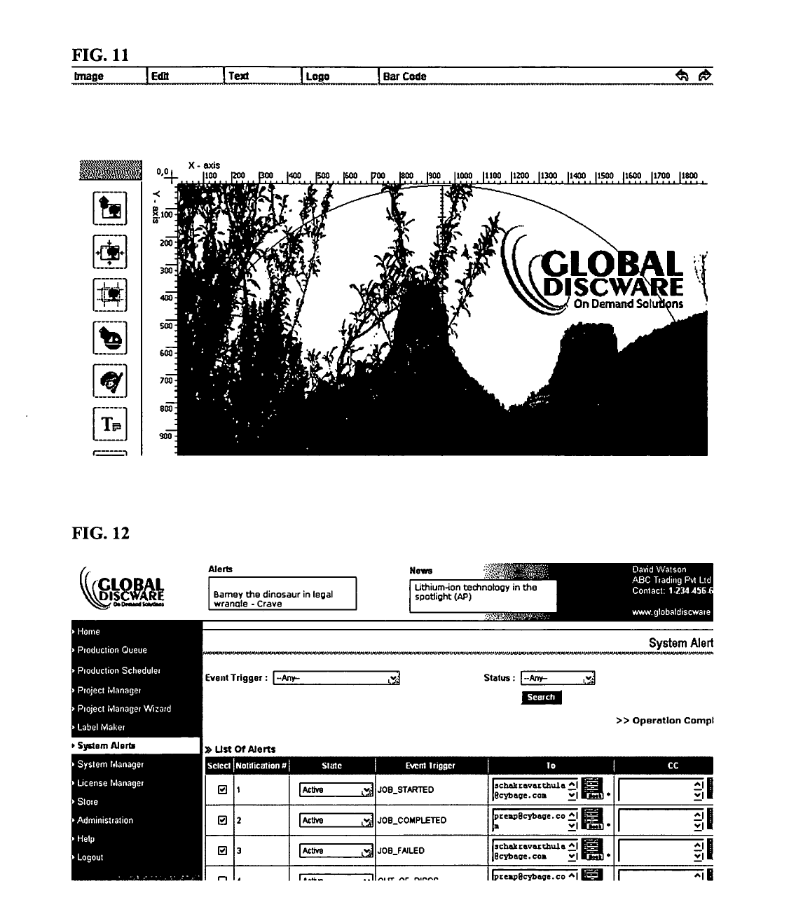

The Label Maker module allows the user to select and edit an image for the disc and disc cover. The opening screen in FIG. 11 provides a list of available images. The user creates a new label by clicking Create New Image or edits an existing one by clicking the image name.

### From the Label Maker WYZIWYG interface, the user can resize or crop the image; change the background; and add a barcode, text, or logo, as is shown in FIG. 12.

### Manage System Alerts

Alerts can be set at the project level or at the system level. End users set up project-level alerts in Project Manager or Project Manager. Administrators set up system-level alerts in the System Alert module. The administrator can set up alerts for any of these event triggers:

The job is started.

The job is completed.

The job fails.

A tower runs out of discs.

A tower needs a new transfer ribbon.

No output spindle is available.

A tower reaches the media threshold specified in the System Manager Tower Details.

The media on the spindle does not match the media specified in the Project Type.

The disc burner has a hardware failure.

The printer has a hardware failure.

The carousel has a hardware failure.

The transport arm has a hardware failure.

A tower needs a new color ribbon.

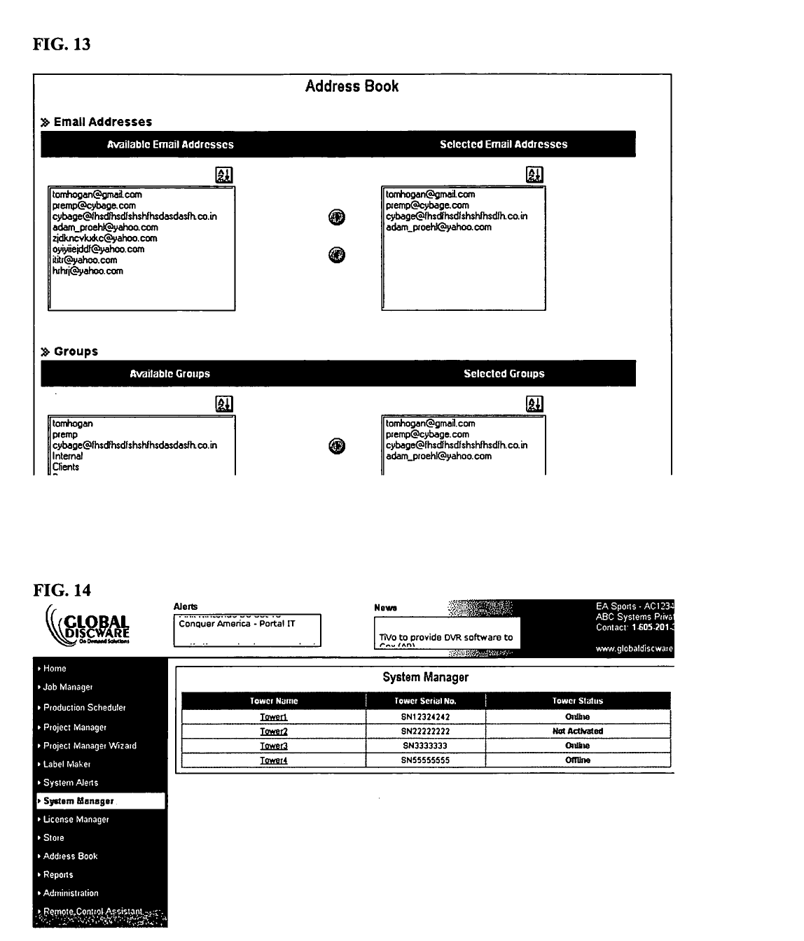

Alerts can be activated, inactivated, and configured but not be created or deleted. The administrator sets details of the email notification, including subject, message content, and addresses for the To and CC fields, as shown in FIG. 13.

To select addresses for the To and CC, the administrator clicks the corresponding address book icon. The Address Book screen opens to FIG. 14. To add an email address or group, the administrator highlights it in the available column and clicks the right arrow. To remove an address or group, the administrator highlights it in the selected column and clicks the left arrow.

### Manage the Tower System

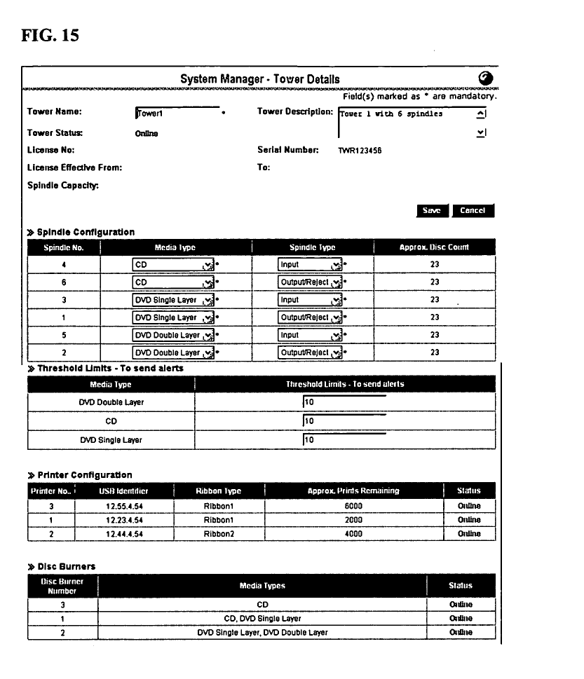

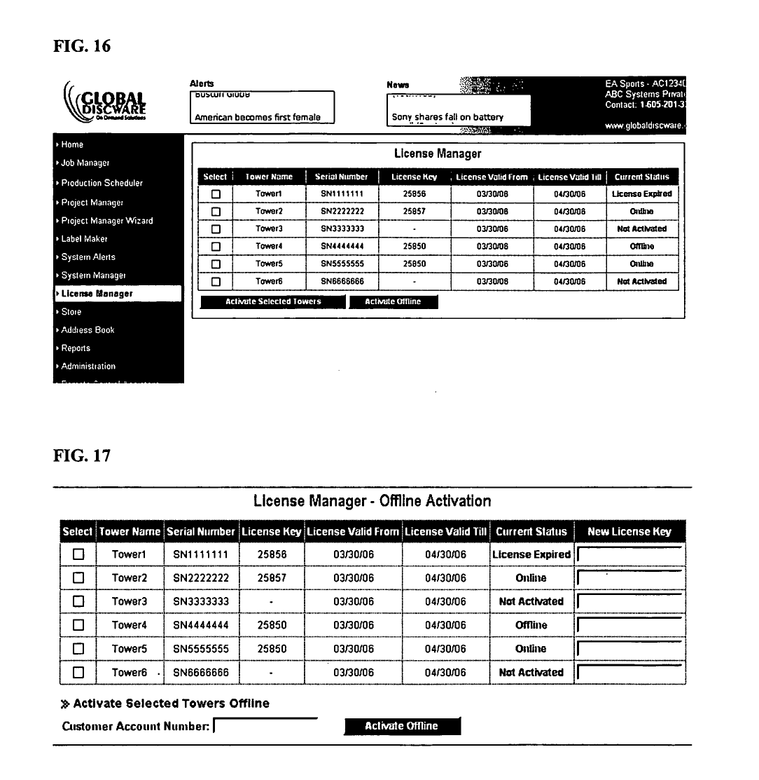

The system administrator uses the System Manager module to view and modify tower information as in FIG. 15. The administrator clicks the tower name to open the Tower Details screen. The Tower Details screen allows the administrator to view tower status, serial number, printer status, and disc burner status as well as modify tower name and description, spindle configuration, and thresholds that trigger alerts, as shown in FIG. 16.

### Manage Licenses

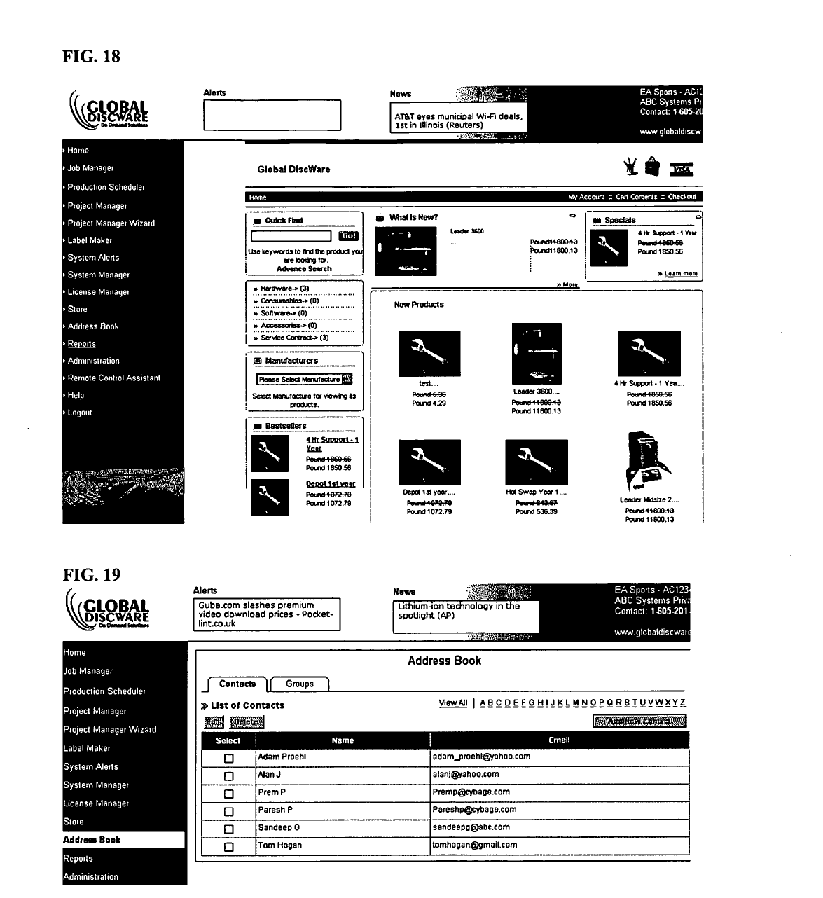

System administrators must activate the towers before using the application. The License Manager module allows administrators to view license information and activate the towers offline through a screen as in FIG. 17. To activate a tower, the administrator clicks Activate Offline. In the Offline Activation screen, the administrator checks the Select box, enters the New License Key and Customer Account Number, and clicks Activate Offline as through the screen in FIG. 18.

### Online Store

The online store, which is connected through the internet connection after ID validation or confirmation or through recognition of the unique identifier, allows users to shop for Global DiscWare products and services in a format that is integrated with the product user interface, as is shown in FIG. 19.

### Manage the Address Book

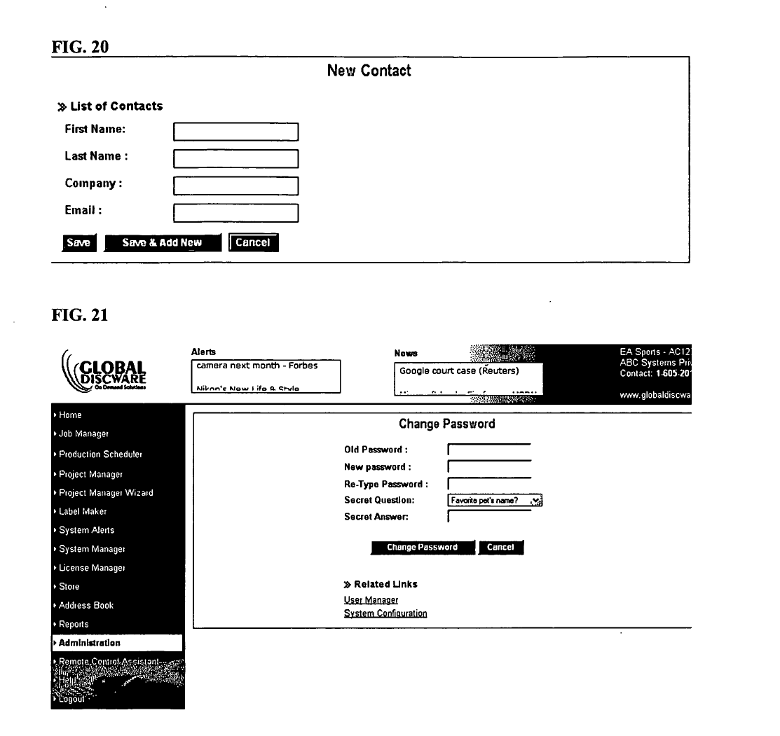

The Address Book module allows the system administrator to add, edit, or delete email contacts for the address book, as shown in FIG. 20. The administrator edits or deletes an address by checking the corresponding Select box and clicking Edit or Delete. To set up a new address, the administrator clicks Add New Contact. The New Contact screen opens, as shown in FIG. 21. The administrator enters the contact information and clicks Save or Save & Add New.

### Generate Reports

### The Reports module provides the ability to generate reports of system use and output based on user, job creation date, project type, and other criteria.

### Administer User Information and System Configuration

The Administration module allows end users to set or change their passwords and allows system administrators to manage users and configure the system. Change Password is the initial screen for the Administration module. From the Change Password screen, any user can change his or her password and the secret question that the system uses for retrieving a forgotten password. System administrators can select User Manager or System Configuration from the Change Password screen shown in FIG. 21.

### User Manager

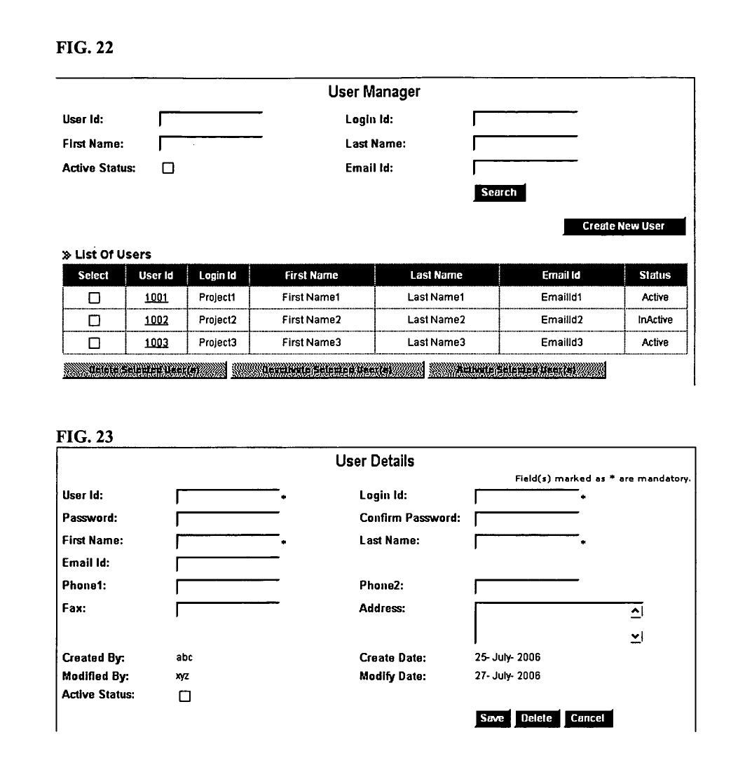

The User Manager screen allows the system administrator to search for users; create or delete user accounts, and activate or deactivate current users as shown in FIG. 22. To delete, activate, or deactivate a user, the administrator checks the corresponding Select box and clicks the appropriate button. When the administrator clicks Create New User or selects a User Id, the User Details screen opens as shown in FIG. 23.

### System Configuration

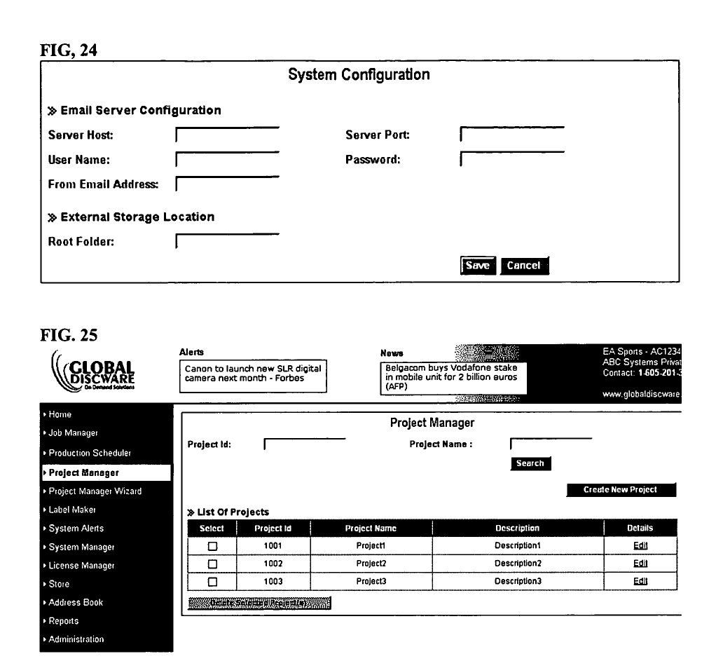

### The System Configuration screen allows the administrator to enter email server configuration, external storage location, and the Reseller information as shown in FIG. 24.

### Integrate with XML

The Remote Control Assistant Module allows the system to integrate with XML.

### Get Help

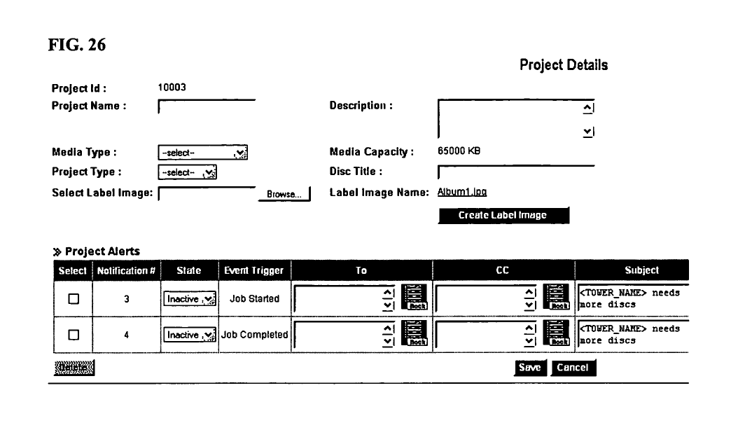

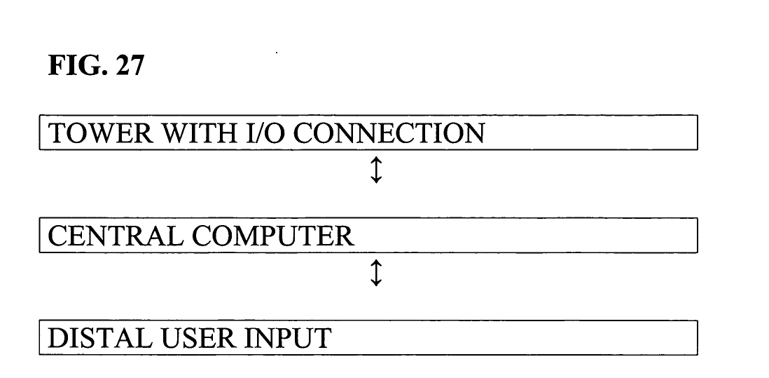

The Help module provides step-by-step instructions for completing end user and system administrator tasks. The help system opens in a separate browser window and is completely searchable as shown in FIG. 25. When the user clicks Create New Project or a Project Id link, the Project Details screen shown in FIG. 26 opens.

One capability of the present technology, sometimes referred to herein as Global DiscWare's Olympus Tower and Olympus Application, is to publish/duplicate CDs or DVDs in quantities from one to 10,000 discs. Users configure the system and control production remotely through the Internet or an intranet. Email alerts notify users when problems occur (for example, when a spindle is out of media or a ribbon breaks). Although the Olympus Tower is the apparatus presently of choice and described and used in the examples and discussions of this technology, any CD/DVD duplicator with multiple CD/DVD recording/duplicating capability may use the practices of the technology described herein.

The Olympus Tower contains multiple disc spindles, such as by way of non-limiting examples, six disc spindles, four recording drives, and a thermal printer. The system generally designates one spindle for output of data to the other spindles carrying writeable discs. A robotic system such as an arm and vacuum pickup mechanism takes discs from the input spindle and moves them to the recording drives, the printer, and the output spindle. The pickup mechanism, by way of non-limiting example, may consist of multiple (e.g., preferably three) vacuum nozzles and a guide to center the disc on the spindle. The mechanism can handle up to four discs at one time.

There are numerous user controls on the system through jobs and projects performed on the system. These user controls are input at the beginning of each job performed on the system.
A project specifies the media type (such as CD, HD-DVD, Blue Ray or DVD), project type (such as music or video), content files, a label image, and events that trigger alerts.
A job specifies the project, quantity requested, preferred tower. Users can create one-time jobs or schedule production on a daily, weekly, or other basis.
   Unique features of the Olympus Tower and Olympus Application include the following:
Scheduling

### Users schedule jobs to run once or on a recurring schedule

Remote control
   All functions are performed remotely through the internet or company intranet. The user can activate or turn off towers, or specify the tower to perform a particular job.
System Alerts
   The system sends email notifications to alert users of problems or status changes. The user determines the events that trigger an alert and sets up an address book with addresses to receive notifications.
Operating Systems

### The application runs on Linux as well as Windows and Macintosh operating systems.

Security
   Security is assigned to users by role. Audit functions allow an administrator to track users' activities or terminate a specific user.
Integrated online store

### Global DiscWare's online store can be integrated with the user interface.

RSS feeds (a file format, the acronym usually standing for “really simple system” and available as Really Simple Syndication (RSS 2.0); Rich Site Summary (RSS 0.91, RSS 1.0); RDF Site Summary (RSS 0.9 and 1.0) The user interface includes RSS feeds of news and alerts.
Remote Control Assistant

### This feature allows integration through XML and FTP.

Label selection and creation

### The user can select an existing graphics file for the disk label or create and edit images with a “What you see is what you get” (WYZIWYG) graphics editor.

Reseller branding

### The name and contact details of the reseller/vendor are displayed in the upper-right corner of the interface.

Unicode character support

### The application uses the Unicode standard to represent text characters in all languages.

J2EE compliance

What is claimed:

1. A method of duplicating information on discs comprising:
providing a disc duplicator device having a) more than three spindles thereon for carrying discs, a first spindle being an output spindle for receiving recorded discs and two spindles being duplicating spindles on which discs are duplicated and b) an automatic disc moving system for transferring discs to the output spindle;
the disc duplicator having c) a processor that directs process steps for duplication of discs in the duplicator; d) has an I/O port for communication to an external processor; and e) allows user input through the I/O port from a user input station;
the disc duplicator processor communicating through the I/O port to an external main computer;
the main computer receiving a communication from the duplicator processor that contains a unique identifier that is unique to the disc duplicator; and
the main computer enabling a user at the user input station to communicate with the main computer to design a disc duplication job after acceptance of the unique identifier.

2. The method of claim 1 wherein the disc duplicator processor operates in a master slave relationship with the main processor, with the disc duplicator processor acting as the slave and directing disc duplicating steps including at least transferring discs to the output spindle from stored software or hardwired memory in the disc duplicator processor, and the main processor providing job selection and job scheduling controls to the user at the user input station.

3. The method of claim 2 wherein the main processor performs at least one step selected from the group consisting of searching for users on-line; creating or deleting user accounts, and activating or deactivating current users.

4. The method of claim 1 wherein a user at the user input station accesses the main computer and sets up project-level alerts in a system alert module, the alerts having at least one alerts selected from the group consisting of:
The job is started;
The job is completed;
The job fails;
A tower runs out of discs;
A tower needs a new transfer ribbon;
No output spindle is available;
A tower reaches the media threshold specified in the System Manager Tower Details;
The media on the spindle does not match the media specified in the Project Type;
The disc burner has a hardware failure;
The printer has a hardware failure;
The carousel has a hardware failure;
The transport arm has a hardware failure; and
A tower needs a new color ribbon.

5. The method of claim 1 wherein a main processor administrator must activate the duplicating devices on-line before a disc duplicator user may actually start duplication of a disc using any job management application received from the main processor.

6. The method of claim 2 wherein the main processor provides the duplicating device processor with a production scheduler module that allows the user to perform at least one step selected from the group consisting of creating a scheduled job, viewing and searching existing scheduled jobs, and changing scheduled job details.

7. The method of claim 1 wherein a user at the user input station selects a format for alert notification outside of on-line communication directly between the disc duplicator processor and the main processor, the format being selected from the group consisting of wireless communication of an alert to a PDA, wireless communication to a cellular phone, facsimile transmission, land-line telephone transmission and e-mail to a user station other than the user input station.

8. The method of claim 1 wherein there is a first user duplicating device in on-line communication with the main processor and a second user duplicating device in communication with the main processor and the main processor shifts a job order from the first user duplicating device to the second user duplication device by on-line commands.

9. The method of claim 8 wherein shifting the job order is done by:
a) a system administrator opening a security screen link;
b) the system administrator selecting a reassignment link;
c) the system administrator identifying a first user from a first user list and a second user from a second user list d) the system administrator selecting at least one first user's projects for reassignment; and
e) assigning at least one first user's project to a second user selected from the second user list.

10. The method of claim 9 wherein all first user projects in queue are selected and transferred to at least one second user.

11. A system for controlling duplication of data on-line comprising:
a disc duplication device having software embedded therein for directing the transfer of information from an information source to multiple discs;
an I/O port for connecting a processor in the disc duplicating device to a main processor;
the main processor;
wherein the processor for the duplicating device is directed by memory stored in the disc duplicating device to move discs and to transfer information from a disc in the disc duplicating device to multiple discs in the disc duplicating device; and
the main processor provides direction on the number of duplicate discs to be duplicated and authorizes or denies authorization to specific disc duplicators in communication with the main processor.
